(19) United States
(12) Patent Application Publication
(10) Pub. No.: US 2025/0152984 A1
(43) Pub. Date: May 15, 2025

(54) SPRINKLER HEAD WITH INTEGRATED FIRE DETECTING MEANS

(71) Applicant: Tyco Fire Products LP, Cranston, RI (US)

(72) Inventor: Harish Subhash Vernekar, Belgaum (IN)

(73) Assignee: Tyco Fire Products LP, Cranston, RI (US)

(21) Appl. No.: 18/941,276

(22) Filed: Nov. 8, 2024

(30) Foreign Application Priority Data
Nov. 10, 2023 (IN) 202341076835

(51) Int. Cl. A62C 37/12; A62C 35/68; A62C 37/14; A62C 37/16

(52) U.S. Cl. CPC A62C 37/12; A62C 35/68; A62C 37/14; A62C 37/16

(57) ABSTRACT

A fire sprinkler includes a body, a seal, a trigger, and a detector. The body includes an inlet, an outlet, and a passageway between the inlet and the outlet. The seal is coupled with the outlet to seal the outlet. The trigger is coupled with the seal such that operation of the trigger releases the seal from the outlet. The detector is coupled with the body. The detector is to cause the operation of the trigger responsive to detection of a fire condition.

### CROSS-REFERENCE TO RELATED APPLICATIONS

The present disclosure claims the benefit of and priority to Indian Application No. 202341076835, filed Nov. 10, 2023, the disclosure of which is incorporated herein by reference in its entirety.

### BACKGROUND

Fire suppression systems include fire detectors that detect occurrence of fire and sprinklers that facilitate fire suppressant flow when a fire event occurs. The sprinkler and the fire detector can be different devices positioned spaced apart from each other. This can increase complexity of fire suppression systems and affect time for trigger operation of sprinklers.

### SUMMARY

At least one aspect relates to a fire sprinkler. The fire sprinkler includes a body, a seal, a trigger, and a detector. The body includes an inlet, an outlet, and a passageway between the inlet and the outlet. The seal is coupled with the outlet to seal the outlet. The trigger is coupled with the seal such that operation of the trigger releases the seal from the outlet. The detector is coupled with the body. The detector is to cause the operation of the trigger responsive to detection of a fire condition.

At least one aspect relates to a sprinkler system. The sprinkler system includes a plurality of sprinklers. Each sprinkler of the plurality of sprinklers includes a body, a seal, a trigger, and a detector. The body includes an inlet, an outlet, and a passageway between the inlet and the outlet. The seal is coupled with the outlet to seal the outlet. The trigger is coupled with the seal such that operation of the trigger releases the seal from the outlet. The detector is coupled with the body. The detector is to cause the operation of the trigger responsive to detection of a fire condition.

At least one aspect relates to a method of providing a fire sprinkler. The method includes providing a body of a fire sprinkler. The method includes coupling a deflector with the body. The method includes coupling a detector with the deflector.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a schematic diagram of an example of a fire suppression system.

FIG. 2 is a front view of an example of a sprinkler head.

FIG. 3 is front view of an example of a deflector.

FIG. 4 is a schematic diagram of an example of a fire detection circuit.

FIG. 5 is a schematic diagram of an example of a trigger arrangement of a sprinkler head.

FIG. 6 is a front view of an example of a sprinkler head.

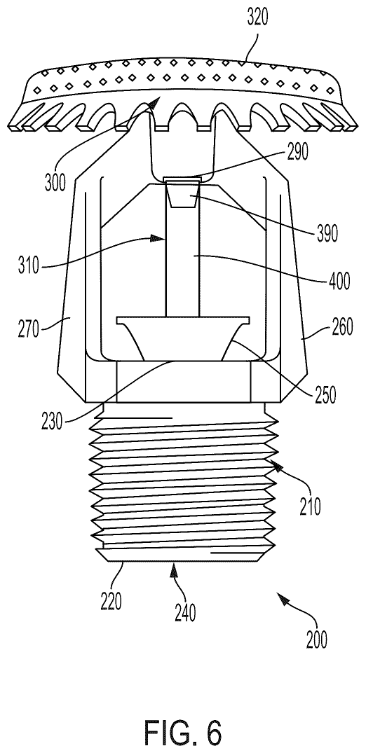

FIG. 7 is a front view of an example of a sprinkler head.

FIG. 8 is a flow diagram of an example of a method of providing a fire sprinkler.

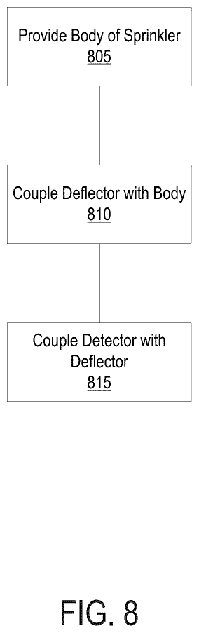

### DETAILED DESCRIPTION

Following below are more detailed descriptions of various concepts related to, and implementations of systems and methods of fire suppression systems and sprinklers of fir suppression systems, such as sprinklers that include an integrated detector. The various concepts introduced above and discussed in greater detail below can be implemented in any of numerous ways, including in wet, dry, or other sprinkler system implementations.

In a typical fire suppression system, a sprinkler and a fire detector are installed spaced apart from each other. The sprinkler is mechanically actuated, wherein a heat sensitive link actuates the sprinkler due to heat generated in a fire event. However, the actuation of the sprinkler may not be at the right time, resulting in improper mitigation of fire. generally to fire suppression systems. More particularly, the present disclosure relates to sprinkler heads employed in a fire suppression system. Further, conventional sprinklers include a heat sensitive member that actuates the sprinkler to allow fire suppressant flow through the sprinkler. The heat sensitive member operates mechanically based on fire related parameters, such as heat or smoke developed in the event of fire. However, conventional sprinklers may not actuate at the right time in the event of fire due to poor mechanical actuation, resulting in improper mitigation of fire.

Systems and methods of the present disclosure can allow for a sprinkler head to have a fire detector provided on a body of sprinkler head. This can facilitate more accurate fire detection and sprinkler triggering, including with reduced delay and/or wasted or untimely fluid output.

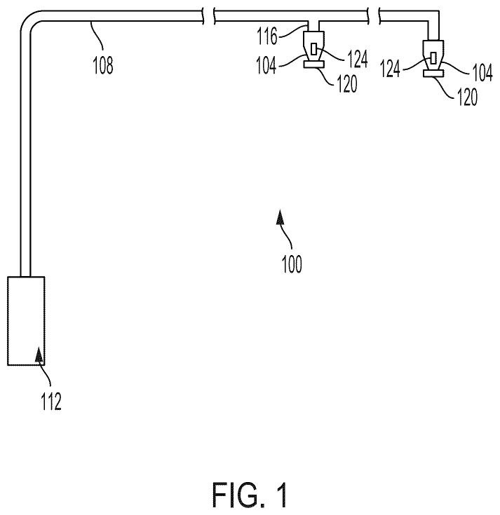

FIG. 1 depicts an example of a fire suppression system 100. The fire suppression system 100 can distribute a fire suppressant agent onto or nearby a fire, extinguishing the fire and preventing the fire from spreading. The fire suppression system 100 can be used alone or in combination with other types of fire suppression systems (e.g., a building sprinkler system, a handheld fire extinguisher). Multiple fire suppression systems 100 can be used in combination with one another to cover a larger area (e.g., each in different rooms of a building). The fire suppression system 100 can be used in a variety of applications. The fire suppression system 100 can be used with a variety of fire suppressant agents, including but not limited to water (e.g., may use powders, liquids, foams, or other fluid or flowable materials). Further, the fire suppression system 100 can be a wet pipe system, a dry pipe system, a deluge system, a pre-action system, an electronically activated fire suppression system, connected fire suppression systems, or the like.

The fire suppression system 100 can include or be coupled with a fluid supply 112. The fluid supply 112 can define an internal volume filled (e.g., partially filled, completely filled) with fire suppressant agent. The fluid supply 112 can provide fluid from a remote or local location to a building in which the fire suppression system 100 is located. The fluid supply may include, for example, a municipal water supply, pump, piping system, tank, cylinder, or any other source of water or fire suppression agent.

Piping 108 (e.g., one or more pipes, tubes, conduits, or fittings) can be fluidly coupled with one or more sprinklers 104. The piping 108 can include vertical pipes 116. The vertical pipes 116 can extend perpendicular from the piping 108. The sprinklers 104 can receive water or other fire suppressant agent from the fluid supply 112 via the piping 108 and the vertical pipes 116. Due to the reduced pressures that can be achieved through the sprinklers 104 while still achieving target outputs of fluid, at least some of the piping 108 can have connections or outlets with relatively lesser diameters, such as 1 inch NPT or ISO-7-RI connections or outlets.

The sprinklers 104 can each define one or more outlets, through which the fire suppressant agent exits and contacts a deflector 120, such as to form a spray of water or other fire suppressant agent that covers a target area. The sprays from the sprinklers 104 then suppress or extinguish fire within that area. The sprinklers 104 can be upright sprinklers, pendent sprinklers, horizontal and/or sidewall sprinklers, for example.

The deflectors 120 of the sprinklers 104 can be shaped to control the spray pattern of the fire suppressant agent leaving the sprinklers 104. The sprinklers 104 can be used as concealed sprinklers, pendent sprinklers, upright sprinklers, water mist nozzles, or any other device for spraying fire suppressant agent, e.g., based on the arrangement of the deflectors 120 relative to a body of the sprinklers 104 and/or a building structure in which the sprinklers 104 are deployed.

The sprinklers 104 can include an activation element (e.g., thermal element) 124. The activation element 124 can change from a first state that prevents fluid flow out of the sprinkler 104 to a second state that permits fluid flow of the sprinkler 104 responsive to a fire condition.

For example, the activation element 124 can include a glass bulb including a fluid that expands responsive to an increase in temperature (e.g., responsive to heat provided to the fluid from a fire), such as to cause the glass bulb to break responsive to the temperature meeting or exceeding a threshold temperature. In another example, the activation element 124 can include a fusible link that includes two or more pieces coupled using a solder than can melt responsive to the temperature meeting or exceeding a threshold temperature. In yet another example, the activation element 124 can include an electric actuator (e.g., an electrically triggered pyrotechnic actuator or electrically actuated bulb or link). The activation element 124 can have a response time index (RTI) less than or equal to 80 (m/s)^{1/2}, or less than or equal to 50 (m/s)^{1/2}. The activation element 124 can have a response time index (RTI) less than or equal to 120 (m/s)^{1/2} and greater than or equal to 15 (m/s)^{1/2}. The activation element 124 can have a temperature rating (e.g., nominal temperature at which the activation element changes from the first state to the second state) of 155 degrees Fahrenheit or greater.

The sprinklers 104 can be arranged (e.g., in a grid or tree arrangement over a storage commodity) to have sprinkler to sprinkler spacings greater than or equal to eight feet by eight feet, including but not limited to fourteen feet by fourteen feet.

Fire suppression systems may include one or more sprinklers and one or more fire detectors. The sprinklers and the fire detectors can work independent of each other. The sprinkler can include a trigger, such as a heat sensitive link that actuates the sprinkler when exposed to heat, while the fire detector detects occurrence of fire based on various parameters such as smoke, temperature, etc. Upon detection of fire, the fire detectors transmit detection signals to a fire control panel. The sprinklers are operated mechanically without any feedback from the fire detectors. It is observed that conventional sprinklers do not actuate at the right time, thereby wasting about 80% of fire suppressant fluid discharged from the sprinkler. Further, the fire suppressant fluid, for example, water, may damage valuable property in a coverage area of sprinkler, if the sprinkler is not actuated at the right time. Electrochemically actuated sprinklers are utilized in a fire suppression systems. One of such sprinklers utilize an electrical signal from a fire detector to ignite a small quantity of explosive that forces a piston to extend into and break the heat sensitive link of the sprinkler. However, this setup is bulky, and use of explosives may not be suitable due to limitations laid in certain fire codes, such as NFPA.

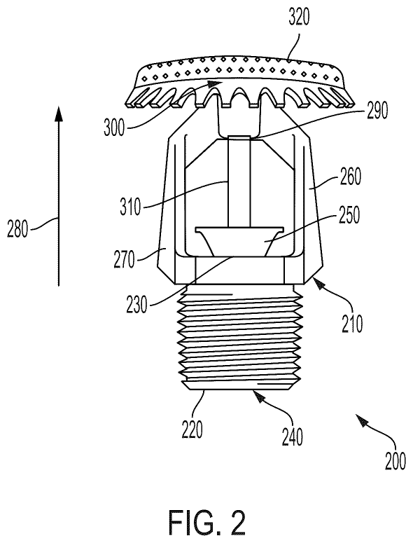

FIG. 2 depicts an example of a sprinkler head 200 (e.g., sprinkler). The sprinklers 104 of FIG. 1 may be implemented using the sprinkler head 200. The sprinkler head 200 can be used in a wet pipe fire suppression system, a dry pipe fire suppression system, a pre-action fire suppression system, or an electronically activated fire suppression system, for example and without limitation.

The sprinkler head 200 can include a body 210, which can include an inlet 220 and an outlet 230. The inlet 220 can connect with a fire suppressant supply pipe, such as to receive fluid (e.g., from a fluid supply) by way of the supply pipe. A portion of the body 210 proximal to the inlet 220, e.g., radially outward from the inlet 220, can have threads to facilitate engagement with the fire suppressant supply pipe. As depicted in FIG. 2, the body 210 may have external threads configured to be coupled with internal threads provided on the fire suppressant supply pipe. The body 210 can include internal threads that are engaged with external threads on the fire suppressant supply pipe. The sprinkler head 200 can be engaged with fire suppressant supply pipe using connectors other than threads the body 210, such as fasteners, clamps, slots, for example.

The body 210 includes a passageway 240 (e.g., internal passageway, fire suppressant flow passage) extending between the inlet 220 and the outlet 230. The sprinkler head 200 includes a seal 250 (e.g., plug, sprinkler button, Belleville spring, or various combinations thereof) provided to obstruct fire suppressant flow through the sprinkler head 200. The seal 250 can be arranged at the outlet 230 of the body 210, such as to seal the outlet. The seal 250 can obstruct fire suppressant fluid flow through the outlet 230 in an unactuated state of the sprinkler head 200. To actuate the sprinkler head 200, the seal 250 can be displaced to allow flow of fire suppressant through the outlet 230. The seal 250 can be displaced based at least on pressure of fluid in the passageway 240 against the seal 250 (e.g., where a counter-balancing force is terminated). The seal 250 can be positioned entirely in the passageway 240 or can partially extend beyond the outlet 230 in a direction 280. The seal 250 can be outside the passageway 240 entirely and seal the outlet 230 to prevent fluid flow.

The body 210 can include a pair of arms 260, 270 that extend from the outlet 230, e.g., in the direction 280. The arms 260, 270 can meet at a junction 290.

The body 210 can include a deflector 300 arranged below the junction 290. The deflector 300 is provided to spread flow of the fire suppressant coming out of the outlet 230 towards a fire area. The arms 260, 270 typically extend in an area between the outlet 230 and the deflector 300.

The sprinkler head 200 can include a trigger 310 (e.g., a link, a heat sensitive link, a bulb, a fusible link (e.g., made of solder), strut, and lever assembly) provided to support the seal 250 in an unactuated state of the sprinkler head 200. The trigger 310 is configured to displace the seal 250 under influence of heat to allow the flow of fire suppressant through the outlet 230. In an event of a fire condition, generated heat affects the trigger 310. Effect of generated heat may differ based on type of the trigger 310. In some embodiments, the trigger 310 includes a glass bulb. Heat generated in the fire event ruptures the glass tube, thereby displacing the seal 250 from its place to allow flow of the fire suppressant through the outlet 230. In some other embodiments, the trigger 310 includes a fusible member the breaks under influence of heat to displace the seal 250 from its place. The heat sensitive trigger 310 may include any of various arrangements to support the seal 250 in the unactuated state of the sprinkler head 200, and to displace the seal 250 under influence of heat to actuate the sprinkler head 200.

The sprinkler head 200 can include a fire detector 320. The fire detector 320 can detect a fire condition, and transmit detection signals to a fire control panel, for example, a fire alarm control panel (FACP). The fire detector 320 is arranged on the body 210 of the sprinkler head 200. In some embodiments, the fire detector 320 is provided on the deflector 300 of the body 210. The fire detector 310 can be provided on and/or in any of various portions of the body 210.

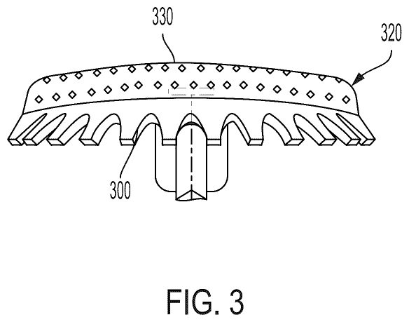

Referring to FIG. 3, the fire detector 320 may include a housing 330 attached to the deflector 300. The housing 330 may have a plurality of air vents to facilitate air circulation between inside of the housing 330 and outside. For example, this can allow for more heat transfer to and/or from the fire detector 320.

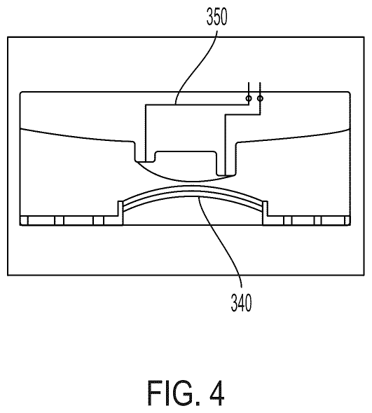

The fire detector 320 can include one or more heat sensing elements secured within the housing 330. The fire detector 320 can be a fixed temperature type detector having one or more passive heat sensing elements. The fire detector 320 can include one or more fire or heat detecting sensors. The sensor can include a bimetallic element 340 as depicted in FIG. 4.

As depicted in FIG. 4, a fire detection circuit 350 can include the bimetallic element 340. In normal operating conditions (e.g., rather than a fire condition, such as sufficient temperature, heat, and/or smoke, or rate of rise of one or more such properties), the fire detection circuit 350 can be in an open state. Responsive to a fire condition, the bimetallic element 340 can change state, e.g., expand due to heat of the fire, and the fire detection circuit 350 can change to a closed state, which can signify occurrence of fire. The FACP can generate an alarm responsive to receiving an indication of the closing of the fire detection circuit 350. The fire detector 320 may have two or more bimetallic strips expanding slowly or quickly based on temperature rise. The fire detector 320 can include various fire/heat sensors/sensing elements.

The sprinkler head 200 can include a trigger arrangement (e.g., trigger activator 360) to heat the trigger 310 in response to detection of fire by the fire detector 320. The trigger arrangement provides heat required to break the trigger 310 in order to actuate the sprinkler head 200. Typically, during the fire event, increase in temperature of air surrounding the sprinkler head 200 is gradual, and thus, it may take time to deform/break the trigger 310. On the other hand, the trigger arrangement can supply sufficient heat to the trigger 310 to actuate the sprinkler head 200 at the right time. Further, heat supplied by the trigger arrangement can be controlled, thereby controlling actuation time of the sprinkler head 200 after the fire event.

The trigger arrangement can include a resistive heating component to heat the trigger 310. The resistive heating component may operate based on Joule's heating technique. The fire detection circuit 350 can include or be coupled with the resistive heating component. When the fire detection circuit 350 is closed post detection of fire, current flowing through the fire detection circuit 350 can heat up the resistive heating component which, in turn, heats the trigger 310 to actuate the sprinkler head 200.

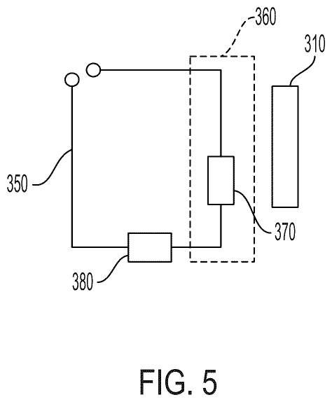

FIG. 5 depicts an example of a trigger activator 360. The trigger activator 360 can include a resistive heating component 370 (e.g., resistor), which can within a threshold distance of the trigger 310. The resistive heating component 370 may be a part of the fire detection circuit 350 having a fire or heat detecting sensor 380. The resistive heating component 370 heats up when the fire detection circuit 350 is closed.

A separate electrical circuit may be provided with the resistive heating component 370. The circuit may be energized by the FACP upon receiving fire detection signal from the fire detector 320.

The fire detection circuit 360 can control an amount of current through the resistive heating component 370 to control actuation of the sprinkler head 200. The amount of current can be regulated based on detection signals received from the fire detector 320, for example. This can facilitate actuation of the sprinkler head 200 at a target time, such as a time associated with a threshold temperature or rate of rise of temperature. The sprinkler head 200 can be actuated even before the trigger 310 reaches its deforming/breaking temperature. The FACP may control amount of current through the resistive heating component 370.

The resistive heating component 370 can be positioned within a threshold distance of the heat sensitive trigger 310, such as to be as close as possible and/or within millimeters or centimeters of the heat sensitive trigger 310. The resistive heating component 370 can be positioned in a space enclosed by the pair of arms 260, 270, the junction 290, and the outlet 230. The resistive heating component 370 can be supported on the junction 290 of the arms 260, 270. The resistive heating component 370 may be in physical contact with the trigger 310 to facilitate faster heat transfer between the resistive heating component 370 and the trigger 310.

As depicted in FIG. 2, the sprinkler head 200 can include a shape memory alloy (SMA) member 390. The SMA member 390 can deform subsequent to detection of fire, and thereby displacing the seal 250. The SMA member 390 can be coupled to the seal 250. The trigger 310 can include a metallic member 400 arranged between the seal 250 and the SMA member 390. The SMA member 390 and the metallic member 400 may be positioned in the space enclosed by the outlet 230, the arms 260, 270, and the junction 290. The SMA member 390 can be on the junction 290.

Responsive to being heated, the SMA member 390 deforms. The SMA member 390 and the metallic member 400 can be so placed that when the SMA member 390 deforms, it displaces the metallic member 400 which results in displacement of the seal 250 from original place. This results in flow of the fire suppressant through the outlet 230.

The SMA member 390 can be heated based on heat from various heat sources. In some embodiments, the SMA member 390 heats up due to heat generated during the fire event or increase in temperature of air surrounding the SMA member 390 due to the fire event.

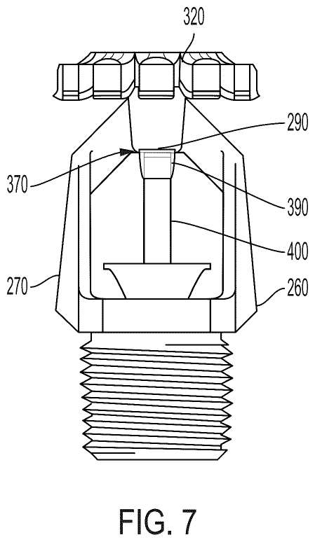

The trigger activator 360 can be used to heat the SMA member 390. As depicted in FIG. 7, the resistive heating component 370 of the trigger activator 360 may be placed proximal to the SMA member 390 to heat the SMA member 390 when fire is detected by the fire detector 320. The resistive heating component 370 can be in the space enclosed by the outlet 230, the arms 260, 270, and the junction 290. The resistive heating component 370 can be between the SMA member 390 and the junction 290.

The SMA member 390 can be made of various SMA materials. The SMA member 390 can be made of Nitinol-a metal alloy of Nickel and Titanium.

The SMA member 390 can have shapes to allow for useful state changes and/or effects on components to which the SMA member 390 is coupled. Shape and size of the SMA member 390 can be determined based on space available within the sprinkler and application area of the sprinkler. The SMA member 390 can have a shape of a helical plate.

FIG. depicts an example of a method 800 of providing a sprinkler, such as to provide a sprinkler that includes an integrated fire detector. The method 800 can be performed as part of manufacturing and/or installing the sprinkler. The method 800 an be performed using various apparatuses or components thereof described herein, including the sprinklers 104 and/or sprinkler head 200.

At 805, a sprinkler can be provided. The sprinkler can be an upright sprinkler. The sprinkler can be used in a fire suppression system or sprinkler system, including, for example and without limitation, a dry pipe system or wet pipe system. The sprinkler can include a body forming an internal passageway, and can include a seal coupled with an outlet of the passageway. The sprinkler can include a trigger, such as a link or bulb-based trigger, which can be used to hold the seal in the outlet (e.g., against pressure of air and/or fluid in the passageway).

At 810, a deflector can be coupled with the sprinkler. The deflector can be shaped to direct fluid according to a target spray pattern, such as in response to release of the seal from the outlet.

At 815, a detector can be coupled with the sprinkler, such as with the deflector or with the body. The detector can be disposed inside the deflector. The detector can be to output an electronic signal indicative of a fire condition. The detector can include one or more temperature, heat, smoke, and/or particular sensors to detect the fire condition. The detector can include or be coupled with an actuator, e.g., a resistor or electrical actuator, that can output energy to trigger operation of the trigger responsive to the fire condition, such as to output heat and/or electrical energy to trigger operation of the trigger.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

What is claimed is:

1. A fire sprinkler comprising:
a body comprising an inlet, an outlet, and a passageway between the inlet and the outlet;
a seal coupled with the outlet to seal the outlet;
a trigger coupled with the seal such that operation of the trigger releases the seal from the outlet; and
a detector coupled with the body, the detector to cause the operation of the trigger responsive to detection of a fire condition.

2. The fire sprinkler of claim 1, comprising:
the trigger comprises a heat sensitive link to displace the seal responsive to heat from at least one of the detector and the fire condition.

3. The fire sprinkler of claim 1, comprising:
the detector is mounted on the body.

4. The fire sprinkler of claim 1, comprising:
an activator to provide at least one of heat and electrical current from the detector to the trigger to activate the trigger.

5. The fire sprinkler of claim 1, comprising:
the body includes a deflector; and
the detector is positioned on the deflector.

6. The fire sprinkler of claim 1, comprising:
the detector includes a fixed temperature detector having a bimetallic element.

7. The fire sprinkler of claim 1, comprising:
the trigger includes a glass bulb or a fusible link.

8. The fire sprinkler of claim 1, comprising:
the detector is inside a deflector coupled with the body, the deflector to output fluid released from the internal passageway responsive to displacement of the seal from the outlet.

9. The fire sprinkler of claim 1, comprising:
the fire sprinkler is arranged as an upright sprinkler.

10. The fire sprinkler of claim 1, comprising:
the detector is to output a signal indicative of the fire condition to a fire control panel.

11. The fire sprinkler of claim 1, comprising:
a temperature at which the detector detects the fire condition is greater than a temperature at which the trigger operates.

12. A sprinkler system, comprising:
a plurality of sprinklers, each sprinkler of the plurality of sprinklers comprising:
a body comprising an inlet, an outlet, and a passageway between the inlet and the outlet;
a seal coupled with the outlet;
a trigger coupled with the seal such that operation of the trigger displaces the seal from the outlet; and
a detector coupled with the body, the detector to cause the operation of the trigger responsive to detection of a fire condition.

13. The sprinkler system of claim 12, comprising:
the detector comprises a resistor to be heated to deliver heat to the trigger to cause operation of the trigger.

14. The sprinkler system of claim 12, comprising:
the body includes a deflector, and the detector is positioned on the deflector.

15. The sprinkler system of claim 12, comprising:
a pair of arms extending from the body to a junction; and
a deflector coupled with the junction, the detector in the deflector.

16. The sprinkler system of claim 12, comprising:
the detector is to transmit a fire detection signal to a control panel based on detection of the fire condition.

17. The sprinkler system of claim 12, the detector comprises a bimetallic element.

18. The sprinkler system of claim 12, comprising:
the plurality of sprinklers are upright sprinklers.

19. The sprinkler system of claim 12, comprising:
an activator to provide at least one of heat and electrical current from the detector to the trigger to activate the trigger.

20. The fire sprinkler of claim 1, comprising:
the detector is inside a deflector coupled with the body, the deflector to output fluid released from the internal passageway responsive to displacement of the seal from the outlet.
